(19) United States
(12) Patent Application Publication
(10) Pub. No.: US 2021/0405163 A1
(43) Pub. Date: Dec. 30, 2021

(54) LIDAR APPARATUS USING DUAL WAVELENGTH

(71) Applicant: MSOTEK CO., LTD, Daejeon (KR)

(72) Inventor: Yong Hyun YEUN, Daejeon (KR)

(21) Appl. No.: 16/618,089

(22) PCT Filed: Nov. 13, 2019
(86) PCT No.: PCT/KR2019/015350

§ 371 Date: Nov. 27, 2019

(30) Foreign Application Priority Data
Nov. 12, 2019 (KR) 10-2019-0143902

(51) Int. Cl. G01S 7/4865; G01S 17/894; G01S 17/10; G01S 17/32

(52) U.S. Cl. CPC G01S 7/4865; G01S 17/32; G01S 17/10; G01S 17/894

(57) ABSTRACT

The present invention is configured to make a wavelength (that is, a first wavelength) of light emitted from a first light source unit and a wavelength (that is, a second wavelength) of light emitted from a second light source unit different from each other, send the light of the first wavelength and the light of the second wavelength to the outside of a light detection and ranging (LIDAR) apparatus, detect the first wavelength reflected and returned by an object positioned outside the LIDAR apparatus by a first light detecting unit, and detect the second wavelength reflected and returned by an object positioned outside the LIDAR apparatus by a second light detecting unit, and may thus simultaneously detect an object positioned at a long distance and an object positioned at a short distance.

### TECHNICAL FIELD

The present invention relates to a light detection and ranging (LIDAR) apparatus that detects a distance from an external object and a form of the external object using light.

### BACKGROUND

Light detection and ranging (LIDAR) is similar to radio detection and ranging (RADAR) in terms of a function, but is different from the RADAR using a radio wave in that it uses the light. For this reason, the LIDAR is also called ‘image RADAR’.

As a LIDAR apparatus, an airborne LIDAR apparatus that emits light in a satellite or an aircraft and receives light scattered by particles in the atmosphere at a ground observation post has been mainly used. The airborne LIDAR apparatus has been used to measure existence and movement of dust, smoke, aerosol, cloud particles, and the like, together with wind information and analyze distribution of dust particles in the atmosphere or a degree of air pollution. Meanwhile, recently, a terrestrial LIDAR apparatus serving to detect an obstacle, model a terrain, and obtain a position up to an object by installing both of a transmitting system and a receiving system on the ground has been actively studied.

The LIDAR apparatus is generally configured to include a transmitting optical system emitting the light, a receiving optical system receiving received light reflected and returned by an object positioned outside the LIDAR apparatus, and an analyzing unit determining a position from the LIDAR apparatus to the object. Here, the analyzing unit determines a time required for transmission and reception of the light to calculate a distance up to the object, and may calculate distances with respect to reflected light received particularly in each direction to create a distance map within an image corresponding to a field of view (FOV).

Meanwhile, a flash-type LIDAR apparatus among LIDAR apparatuses according to the related art calculates a distance from the LIDAR apparatus to an object by a method of simultaneously emitting light having a wide beam width and simultaneously obtaining light reflected and returned by the object positioned outside the LIDAR apparatus. In order to implement such a flash-type LIDAR apparatus, a light source consuming a very high power is required, and a cost of the LIDAR apparatus is thus very expensive. In addition, the light source consuming the very high power has a very large size, which causes an increase in an entire size of the LIDAR apparatus.

In addition, a scan-type LIDAR apparatus among the LIDAR apparatuses according to the related art emits light having a pulse form in a scan type to an object positioned outside the LIDAR apparatus to calculate a distance from the LIDAR apparatus to the object. Such a scan-type LIDAR apparatus may emit the light up to a relatively distant position, but resolution of the object, which is a detection target, is lower than that of the flash-type LIDAR apparatus.

### RELATED ART DOCUMENT

### Patent Document

US 2011/0216304 (published on Sep. 8, 2011).

### SUMMARY

An object of the present invention is to provide a light detection and ranging (LIDAR) apparatus capable of simultaneously detecting an object positioned at a long distance and an object positioned at a short distance, reducing power consumed in order to emit light, and having a reduced entire size.

### Technical Solution

In one general aspect, a light detection and ranging (LIDAR) apparatus using dual wavelengths includes: a first light source unit emitting light of a first wavelength; a scan mirror installed on a path of the light emitted from the first light source unit so that a direction of a reflection surface thereof is varied over time and scanning the light of the first wavelength emitted from the first light source unit; a second light source unit emitting light of a second wavelength which is a wavelength different from the first wavelength; a first dichroic mirror reflecting the light of the first wavelength scanned by the scan mirror, transmitting the light of the second wavelength emitted from the second light source unit, and sending the light of the first wavelength and the light of the second wavelength to the outside of the LIDAR apparatus; a second dichroic mirror reflecting the light of the first wavelength reflected and returned by an object positioned outside the LIDAR apparatus and transmitting the light of the second wavelength reflected and returned by an object positioned outside the LIDAR apparatus; a first light detecting unit detecting the light of the first wavelength reflected by the second dichroic mirror; and a second light detecting unit detecting the light of the second wavelength transmitted through the second dichroic mirror.

The first light source unit may be a pulsed laser diode (PLD) emitting the light of the first wavelength in a pulse form.

The first light detecting unit may be an avalanche photo diode (APD).

The second light source unit may be a continuous wave laser diode (CWLD) emitting the light of the second wavelength in a continuous wave form.

The second light detecting unit may be a time-of-flight (TOF) sensor.

The scan mirror may scan the light of the first wavelength in a first angle range, and the second light source unit may emit the light of the second wavelength in a second angle range which is an angle range wider than the first angle range.

The LIDAR apparatus using dual wavelengths may further include a first wide angle lens extending each of the angle ranges of the light of the first wavelength reflected by the first dichroic mirror and the light of the second wavelength transmitted through the first dichroic mirror.

The LIDAR apparatus using dual wavelengths may further include a second wide angle lens narrowing each of the angle ranges of the light of the first wavelength reflected and returned by the object and the light of the second wavelength reflected and returned by the object.

In another general aspect, a LIDAR apparatus using dual wavelengths includes: a first light source unit emitting light of a first wavelength; a scan mirror installed on a path of the light emitted from the first light source unit so that a direction of a reflection surface thereof is varied over time and scanning the light of the first wavelength emitted from the first light source unit; a first dichroic mirror reflecting the light of the first wavelength scanned by the scan mirror and sending the light of the first wavelength to the outside of the LIDAR apparatus; a second light source unit emitting light of a second wavelength which is a wavelength different from the first wavelength; a second dichroic mirror reflecting the light of the second wavelength emitted from the second light source unit and sending the light of the second wavelength to the outside of the LIDAR apparatus; a first light detecting unit detecting the light of the first wavelength reflected and returned by an object positioned outside the LIDAR apparatus and transmitted through the second dichroic mirror; and a second light detecting unit detecting the light of the second wavelength reflected and returned by an object positioned outside the LIDAR and transmitted through the first dichroic mirror.

The first light source unit may be a PLD emitting the light of the first wavelength in a pulse form.

The first light detecting unit may be an APD.

The second light source unit may be a CWLD emitting the light of the second wavelength in a continuous wave form.

The second light detecting unit may be a TOF sensor.

The scan mirror may scan the light of the first wavelength in a first angle range, and the second light source unit may emit the light of the second wavelength in a second angle range which is an angle range wider than the first angle range.

The LIDAR apparatus using dual wavelengths may further include: a first wide angle lens extending the angle range of the light of the first wavelength reflected by the first dichroic mirror; and a second wide angle lens extending the angle range of the light of the second wavelength reflected by the second dichroic mirror.

In still another aspect, a LIDAR apparatus using dual wavelengths includes: a first light source unit emitting light of a first wavelength; a scan mirror installed on a path of the light emitted from the first light source unit so that a direction of a reflection surface thereof is varied over time, scanning the light of the first wavelength emitted from the first light source unit, and sending the scanned light to the outside of the LIDAR apparatus; a second light source unit emitting light of a second wavelength which is a wavelength different from the first wavelength and sending the light of the second wavelength to the outside of the LIDAR apparatus; a dichroic mirror reflecting the light of the first wavelength reflected and returned by an object positioned outside the LIDAR apparatus and transmitting the light of the second wavelength reflected and returned by an object positioned outside the LIDAR apparatus; a first light detecting unit detecting the light of the first wavelength reflected by the dichroic mirror; and a second light detecting unit detecting the light of the second wavelength transmitted through the dichroic mirror.

The first light source unit may be a PLD emitting the light of the first wavelength in a pulse form.

The first light detecting unit may be an APD.

The second light source unit may include one or more light emitting diodes (LEDs) emitting the light of the second wavelength in a continuous wave form.

The LIDAR apparatus using dual wavelengths may further include a lens beneath which the one or more LEDs are disposed, wherein the one or more LEDs are disposed beneath the lens and emit the light of the second wavelength toward an upper portion of the lens.

The second light detecting unit may be a TOF sensor.

The scan mirror may scan the light of the first wavelength in a first angle range, and the second light source unit may emit the light of the second wavelength in a second angle range which is an angle range wider than the first angle range.

The LIDAR apparatus using dual wavelengths may further include a wide angle lens narrowing each of the angle ranges of the light of the first wavelength reflected and returned by the object and the light of the second wavelength reflected and returned by the object.

### Advantageous Effects

The present invention is configured to make a wavelength (that is, a first wavelength) of light emitted from the first light source unit and a wavelength (that is, a second wavelength) of light emitted from the second light source unit different from each other, send the light of the first wavelength and the light of the second wavelength to the outside of the LIDAR apparatus, detect the first wavelength reflected and returned by an object positioned outside the LIDAR apparatus by the first light detecting unit, and detect the second wavelength reflected and returned by an object positioned outside the LIDAR apparatus by the second light detecting unit, and may thus simultaneously detect an object positioned at a long distance and an object positioned at a short distance.

In addition, the present invention is configured to detect the object positioned at the long distance through the light of the first wavelength having the pulse form and detect the object positioned at the short distance through the light of the second wavelength having the continuous wave form, and consumed power is thus reduced as compared with the flash-type LIDAR apparatus according to the related art, such that a cost of the LIDAR apparatus may be reduced and a size of the LIDAR apparatus may also be reduced.

In addition, the present invention is configured to scan the light of the first wavelength in the first angle range to detect the object positioned at the long distance and emit the light of the second wavelength in the second angle range, which is the angle range wider than the first angle range, to detect the object positioned at the short distance, and may thus prevent unnecessary power consumption caused by increasing the first angle range.

### BRIEF DESCRIPTION OF THE DRAWINGS

FIG. 1 is a view illustrating a light detection and ranging (LIDAR) apparatus using dual wavelengths according to a first exemplary embodiment of the present invention;

FIG. 2 is a view illustrating a LIDAR apparatus using dual wavelengths according to a second exemplary embodiment of the present invention; and

FIG. 3 is a view illustrating a LIDAR apparatus using dual wavelengths according to a third exemplary embodiment of the present invention.

### DETAILED DESCRIPTION

Hereinafter, various exemplary embodiments of a light detection and ranging (LIDAR) apparatus using dual wavelengths according to the present invention will be described in detail with reference to the accompanying drawings. The accompanying drawings are provided in order to sufficiently transfer the spirit of the present invention to those skilled in the art, and the present invention is not limited only to the accompanying drawings, but may be implemented in another form without departing from the spirit and scope of the present invention.

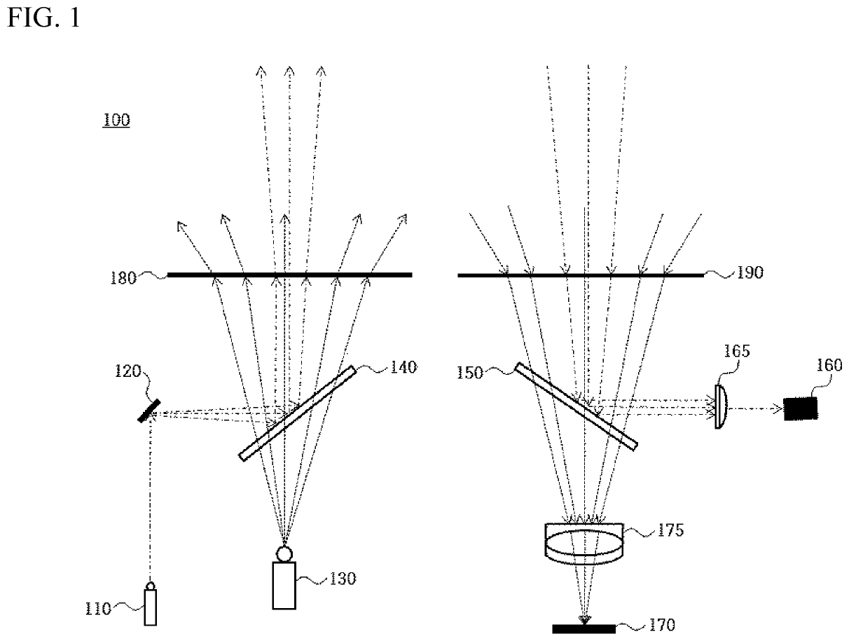

FIG. 1 is a view illustrating a LIDAR apparatus using dual wavelengths according to a first exemplary embodiment of the present invention.

Referring to FIG. 1, a LIDAR apparatus 100 using dual wavelengths according to a first exemplary embodiment of the present invention includes a first light source unit 110, a scan mirror 120, a second light source unit 130, a first dichroic mirror 140, a second dichroic mirror 150, a first light detecting unit 160, and a second light detecting unit 170.

The first light source unit 110 emits light of a first wavelength. In this case, the light of the first wavelength is to detect an object positioned outside the LIDAR apparatus 100 and positioned at a relatively long distance (for example, 200 m or more). It is sufficient that the LIDAR apparatus 100 may detect whether or not the object is positioned at the long distance, and the LIDAR apparatus 100 does not need to detect the object at high resolution. Therefore, it is preferable that the first light source unit 110 is a pulsed laser diode (PLD) emitting the light of the first wavelength in a pulse form. In a case where the first light source unit 110 is the PLD, the first light source unit 110 may emit the light of the first wavelength with relatively small power. In this case, since the light of the first wavelength has the pulse form, the light of the first wavelength may arrive at a relatively long distance from the LIDAR apparatus 100.

The light of the first wavelength emitted from the first light source unit 110 is incident to the scan mirror 120. Here, the scan mirror 120 may be a micro-electro mechanical systems (MEMS) mirror in which a mirror is disposed on a MEMS semiconductor.

The scan mirror 120 is installed on a path of the light emitted from the first light source unit 110 so that a direction of a reflection surface thereof is varied over time, and scans the light of the first wavelength emitted from the first light source unit 110 toward a first dichroic mirror 140 described below. For example, the scan mirror 120 is disposed on the path of the light of the first wavelength so as to be rotatable in a biaxial direction, such that the direction of the reflection surface of the scan mirror 120 may be varied over time. Here, the biaxial direction may refer to a horizontal direction and a vertical direction on the basis of a front surface of the scan mirror 120 in FIG. 1. In this case, the scan mirror 120 may rotate multiple times during a period in which it rotates once from the top to the bottom.

The second light source unit 130 emits light of a second wavelength. In this case, the second wavelength is a wavelength different from the first wavelength. For example, in the present invention, the first wavelength may be 905 nm, and the second wavelength may be 800 nm.

The light of the second wavelength is to detect an object positioned outside the LIDAR apparatus 100 and positioned at a relatively short distance (for example, 20 m or less). The LIDAR apparatus 100 needs to detect the object positioned at the relatively short distance at high resolution. The reason is that when the LIDAR apparatus 100 is mounted in, for example, a vehicle or the like and such a vehicle is parked or travels at a low speed, an object in the vicinity of the vehicle needs to be detected at high resolution in order to ensure safety of the vehicle and a driver of the vehicle.

Therefore, it is preferable that the second light source unit 130 is a continuous wave laser diode (CWLD) emitting the light of the second wavelength in a continuous wave form. In a case where the second light source unit 120 is the CWLD, power consumed by the second light source unit 130 to emit the light of the second wavelength may be higher than power consumed by the first light source unit 110 to emit the light of the first wavelength. In this regard, the flash-type LIDAR apparatus according to the related art requires a light source consuming a very high power in order to simultaneously detect an object positioned at a short distance and an object positioned at a long distance. However, in the first exemplary embodiment of the present invention, the LIDAR apparatus 100 is configured to detect the object positioned at the long distance through the light of the first wavelength having the pulse form and detect the object positioned at the short distance through the light of the second wavelength having the continuous wave form, and consumed power is thus reduced as compared with the flash-type LIDAR apparatus according to the related art, such that a cost of the LIDAR apparatus may be reduced and a size of the LIDRA apparatus may also be reduced.

The first dichroic mirror 140 serves to reflect the light of the first wavelength scanned by the scan mirror 120, transmit the light of the second wavelength emitted from the second light source unit 130, and send the light of the first wavelength and the light of the second wavelength to the outside of the LIDAR apparatus 100. That is, the first dichroic mirror 140 selectively reflects or transmits the light incident thereon according to a wavelength of the light.

The scan mirror 120 may scan the light of the first wavelength in a first angle range and allow the scanned light to be incident on the first dichroic mirror 140. In addition, the second light source unit 130 may emit the light of the second wavelength in a second angle range, which is an angle range wider than the first angle range, and allow the emitted light to be incident to the first dichroic mirror 140.

The light of the first wavelength scanned by the scan mirror 120 is to detect the object positioned at the relatively long distance, and an angle range of the LIDAR apparatus 100 does not need to be large when the LIDAR apparatus 100 detects the object positioned at the long distance. That is, since it is sufficient that the LIDAR apparatus 100 detects only whether or not the object is positioned at a long distance of a front surface, unnecessary power consumption caused by increasing the first angle range needs to be prevented. Therefore, it is preferable that the scan mirror 120 scans the light of the first wavelength in a relatively narrow angle range (for example, about 10°) and allows the scanned light to be incident on the first dichroic mirror 140.

The light of the second wavelength emitted from the second light source unit 130 is to detect the object positioned at the relative short distance, and it is preferable to make an angle range of the LIDAR apparatus 100 large when the LIDAR apparatus 100 detects the object positioned at the short distance. That is, the LIDAR apparatus 100 needs to detect not only the object positioned at the short distance in front of the LIDAR apparatus 100, but also the object positioned at the short distance at the high resolution so that the vehicle may be stably parked or stably travel at the low speed. Therefore, it is preferable that the second light source unit 130 emits the light of the second wavelength in a relatively wide angle range (for example, about 60°) and allows the emitted light to be incident on the first dichroic mirror 140.

In a case of extending an angle range of the light of the first wavelength reflected by the first dichroic mirror 140, a possibility that the object positioned at the long distance will be detected by the light of the first wavelength may be increased. In addition, in a case of extending an angle range of the light of the second wavelength transmitted through the first dichroic mirror, a possibility that the object positioned at the short distance will be detected by the light of the second wavelength may be increased. Therefore, it is preferable that the LIDAR apparatus 100 according to the first exemplary embodiment of the present invention includes a first wide angle lens 180 extending each of the angle ranges of the light of the first wavelength reflected by the first dichroic mirror 140 and the light of the second wavelength transmitted through the first dichroic mirror 140.

In a case where an object is positioned outside the LIDAR apparatus 100, the light of the first wavelength or the light of the second wavelength sent from the first dichroic mirror 140 is reflected and returned by the object. In a case where the light of the first wavelength or the light of the second wavelength is incident on the object, scattered reflection is generated on the object. Therefore, the light of the first wavelength or the light of the second wavelength reflected and returned by the object may be incident to the first light detecting unit 160 or the second light detecting unit 170 through the second dichroic mirror 150.

The second dichroic mirror 150 serves to reflect the light of the first wavelength reflected and returned by the object positioned outside the LIDAR apparatus 100 and transmit the light of the second wavelength reflected and returned by the object positioned outside the LIDAR apparatus 100. That is, the second dichroic mirror 150 selectively reflects or transmits the light incident thereon according to a wavelength of the light, similar to the first dichroic mirror 140.

Meanwhile, in a case where each of the angle ranges of the light of the first wavelength and the light of the second wavelength is extended by the first wide angle lens 180, each of the angle ranges of the light of the first wavelength and the light of the second wavelength that are reflected and returned by the object needs to be narrowed in order for the first light detecting unit 160 or the second light detecting unit 170 to detect the light at high resolution. Therefore, in the LIDAR apparatus 100 according to the first exemplary embodiment of the present invention, it is preferable that a second wide angle lens 190 narrowing each of the angle ranges of the light of the first wavelength and the light of the second wavelength that are reflected and returned by the object is disposed in front of the second dichroic mirror 150.

The first light detecting unit 160 detects the light of the first wavelength reflected by the second dichroic mirror 150. Since the light of the first wavelength is light having the pulse form, it is preferable that the first light detecting unit 160 is an avalanche photo diode (APD) capable of detecting the light having the pulse form. In addition, a condensing lens 165 may be provided between the second dichroic mirror 150 and the first light detecting unit 160 so that the first light detecting unit 160 may detect the light of the first wavelength at higher resolution.

The second light detecting unit 170 detects the light of the second wavelength transmitted through the second dichroic mirror 150. Since the light of the second wavelength is light having the continuous wave form, it is preferable that the second light detecting unit 170 is a time-of-flight (TOF) sensor capable of detecting the light having the continuous wave form through a phase difference. In addition, an image optical system 175 may be provided between the second dichroic mirror 150 and the second light detecting unit 170 so that the second light detecting unit 170 may detect the light of the second wavelength at higher resolution.

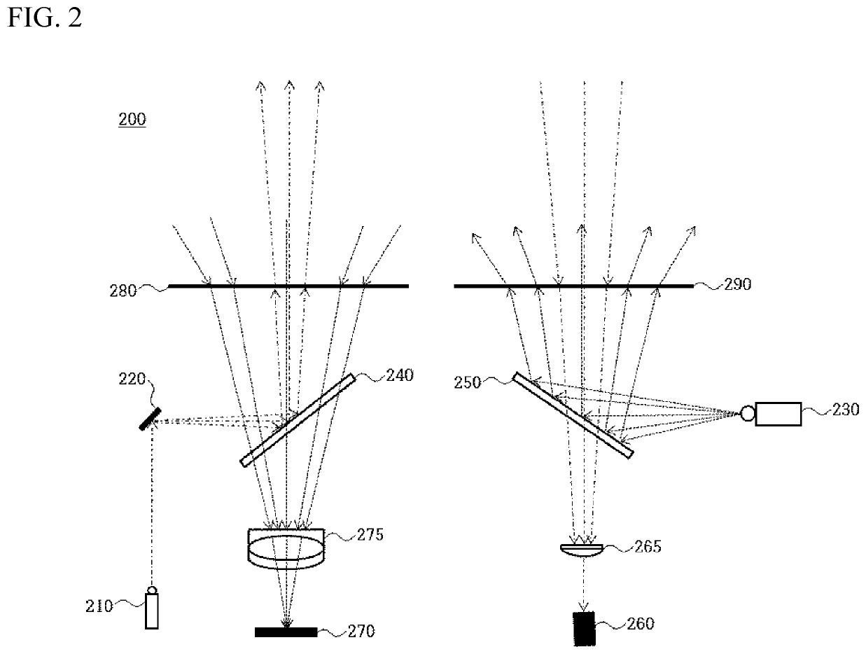

FIG. 2 is a view illustrating a LIDAR apparatus using dual wavelengths according to a second exemplary embodiment of the present invention.

Referring to FIG. 2, a LIDAR apparatus 200 using dual wavelengths according to a second exemplary embodiment of the present invention includes a first light source unit 210, a scan mirror 220, a second light source unit 230, a first dichroic mirror 240, a second dichroic mirror 250, a first light detecting unit 260, and a second light detecting unit 270.

The LIDAR apparatus 100 using dual wavelengths according to the first exemplary embodiment of the present invention is configured so that the first light source unit 110 and the second light source unit 130 are disposed adjacent to each other and the first light detecting unit 160 and the second light detecting unit 170 are disposed adjacent to each other, while the LIDAR apparatus 200 using dual wavelengths according to the second exemplary embodiment of the present invention is configured so that a first light source unit 210 and a second light detecting unit 270 are disposed adjacent to each other and a second light source unit 230 and a first light detecting unit 260 are disposed adjacent to each other.

The first light source unit 210 emits light of a first wavelength. In this case, the light of the first wavelength is to detect an object positioned outside the LIDAR apparatus 200 and positioned at a relatively long distance (for example, 200 m or more). It is sufficient that the LIDAR apparatus 200 may detect whether or not the object is positioned at the long distance, and the LIDAR apparatus 200 does not need to detect the object at high resolution. Therefore, it is preferable that the first light source unit 210 is a PLD emitting the light of the first wavelength in a pulse form. In a case where the first light source unit 210 is the PLD, the first light source unit 210 may emit the light of the first wavelength with relatively small power. In this case, since the light of the first wavelength has the pulse form, the light of the first wavelength may arrive at a relatively long distance from the LIDAR apparatus 200.

The light of the first wavelength emitted from the first light source unit 210 is incident to the scan mirror 220. Here, the scan mirror 220 may be a MEMS mirror in which a mirror is disposed on a MEMS semiconductor.

The scan mirror 220 is installed on a path of the light emitted from the first light source unit 210 so that a direction of a reflection surface thereof is varied over time, and scans the light of the first wavelength emitted from the first light source unit 210 toward a first dichroic mirror 240 described below. For example, the scan mirror 220 is disposed on the path of the light of the first wavelength so as to be rotatable in a biaxial direction, such that the direction of the reflection surface of the scan mirror 220 may be varied over time. Here, the biaxial direction may refer to a horizontal direction and a vertical direction on the basis of a front surface of the scan mirror 220 in FIG. 2. In this case, the scan mirror 220 may rotate multiple times during a period in which it rotates once from the top to the bottom.

The first dichroic mirror 240 serves to reflect the light of the first wavelength scanned by the scan mirror 220 and send the light of the first wavelength to the outside of the LIDAR apparatus 200. In addition, the first dichroic mirror 240 serves to transmit the light of the second wavelength reflected and returned by the object positioned outside the LIDAR apparatus 200. That is, the first dichroic mirror 240 selectively reflects or transmits the light incident thereon according to a wavelength of the light.

The second light source unit 230 emits light of a second wavelength. In this case, the second wavelength is a wavelength different from the first wavelength. For example, in the present invention, the first wavelength may be 905 nm, and the second wavelength may be 800 nm.

The light of the second wavelength is to detect an object positioned outside the LIDAR apparatus 200 and positioned at a relatively short distance (for example, 20 m or less). The LIDAR apparatus 200 needs to detect the object positioned at the relatively short distance at high resolution. The reason is that when the LIDAR apparatus 200 is mounted in, for example, a vehicle or the like and such a vehicle is parked or travels at a low speed, an object in the vicinity of the vehicle needs to be detected at high resolution in order to ensure safety of the vehicle and a driver of the vehicle.

Therefore, it is preferable that the second light source unit 230 is a CWLD emitting the light of the second wavelength in a continuous wave form. In a case where the second light source unit 230 is the CWLD, power consumed by the second light source unit 230 to emit the light of the second wavelength may be higher than power consumed by the first light source unit 210 to emit the light of the first wavelength. In this regard, the flash-type LIDAR apparatus according to the related art requires a light source consuming a very high power in order to simultaneously detect an object positioned at a short distance and an object positioned at a long distance. However, in the second exemplary embodiment of the present invention, the LIDAR apparatus 200 is configured to detect the object positioned at the long distance through the light of the first wavelength having the pulse form and detect the object positioned at the short distance through the light of the second wavelength having the continuous wave form, and consumed power is thus reduced as compared with the flash-type LIDAR apparatus according to the related art, such that a cost of the LIDAR apparatus may be reduced and a size of the LIDAR apparatus may also be reduced.

The scan mirror 220 may scan the light of the first wavelength in a first angle range and allow the scanned light to be incident on the first dichroic mirror 240. In addition, the second light source unit 230 may emit the light of the second wavelength in a second angle range, which is an angle range wider than the first angle range, and allow the emitted light to be incident to a second dichroic mirror 250 described below.

The light of the first wavelength scanned by the scan mirror 220 is to detect the object positioned at the relatively long distance, and an angle range of the LIDAR apparatus 200 does not need to be large when the LIDAR apparatus 200 detects the object positioned at the long distance. That is, since it is sufficient that the LIDAR apparatus 200 detects only whether or not the object is positioned at a long distance of a front surface, unnecessary power consumption caused by increasing the first angle range needs to be prevented. Therefore, it is preferable that the scan mirror 220 scans the light of the first wavelength in a relatively narrow angle range (for example, about 10°) and allows the scanned light to be incident on the first dichroic mirror 240.

The light of the second wavelength emitted from the second light source unit 230 is to detect the object positioned at the relative short distance, and it is preferable to make an angle range of the LIDAR apparatus 200 large when the LIDAR apparatus 200 detects the object positioned at the short distance. That is, the LIDAR apparatus 200 needs to detect not only the object positioned at the short distance in front of the LIDAR apparatus 200, but also the object positioned at the short distance at the high resolution so that the vehicle may be stably parked or stably travel at the low speed. Therefore, it is preferable that the second light source unit 230 emits the light of the second wavelength in a relatively wide angle range (for example, about 60°) and allows the emitted light to be incident on the second dichroic mirror 250.

The second dichroic mirror 250 serves to reflect the light of the second wavelength emitted from the second light source unit 230 and send the light of the second wavelength to the outside of the LIDAR apparatus 200. In addition, the second dichroic mirror 250 serves to transmit the light of the first wavelength reflected and returned by the object positioned outside the LIDAR apparatus 200. That is, the second dichroic mirror 250 selectively reflects or transmits the light incident thereon according to a wavelength of the light.

In a case of extending an angle range of the light of the first wavelength reflected by the first dichroic mirror 240, a possibility that the object positioned at the long distance will be detected by the light of the first wavelength may be increased. Therefore, it is preferable that the LIDAR apparatus 200 according to the second exemplary embodiment of the present invention includes a first wide angle lens 280 extending the angle range of the light of the first wavelength reflected by the first dichroic mirror 240. Similarly, in a case of extending an angle range of the light of the second wavelength reflected by the second dichroic mirror 250, a possibility that the object positioned at the short distance will be detected by the light of the second wavelength may be increased. Therefore, it is preferable that the LIDAR apparatus 200 according to the second exemplary embodiment of the present invention includes a second wide angle lens 290 extending the angle range of the light of the second wavelength reflected by the second dichroic mirror 250.

In a case where an object is positioned outside the LIDAR apparatus 200, the light of the first wavelength sent from the first dichroic mirror 240 is reflected and returned by the object. In a case in which the light of the first wavelength is incident on the object, scattered reflection is generated on the object. Therefore, the light of the first wavelength reflected and returned by the object may be incident on the first light detecting unit 260 through the second dichroic mirror 250. In addition, in a case where an object is positioned outside the LIDAR apparatus 200, the light of the second wavelength sent from the second dichroic mirror 250 is reflected and returned by the object. In a case in which the light of the second wavelength is incident on the object, scattered reflection is generated on the object. Therefore, the light of the second wavelength reflected and returned by the object may be incident on the second light detecting unit 270 through the first dichroic mirror 240.

Meanwhile, even though the angle range of the light of the first wavelength is extended by the first wide angle lens 280, the angle range of the light of the first wavelength reflected and returned by the object may be narrowed by the second wide angle lens 290. Therefore, the first light detecting unit 260 may detect the light of the first wavelength at relatively high resolution. In addition, even though the angle range of the light of the second wavelength is extended by the second wide angle lens 290, the angle range of the light of the second wavelength reflected and returned by the object may be narrowed by the first wide angle lens 280. Therefore, the second light detecting unit 270 may detect the light of the second wavelength at relatively high resolution.

The first light detecting unit 260 detects the light of the first wavelength reflected and returned by the object and transmitted through the second dichroic mirror 250. Since the light of the first wavelength is light having the pulse form, it is preferable that the first light detecting unit 260 is an APD capable of detecting the light having the pulse form. In addition, a condensing lens 265 may be provided between the second dichroic mirror 250 and the first light detecting unit 260 so that the first light detecting unit 260 may detect the light of the first wavelength at higher resolution.

The second light detecting unit 270 detects the light of the second wavelength reflected and returned by the object and transmitted through the first dichroic mirror 240. Since the light of the second wavelength is light having the continuous wave form, it is preferable that the second light detecting unit 270 is a TOF sensor capable of detecting the light having the continuous wave form through a phase difference. In addition, an image optical system 275 may be provided between the first dichroic mirror 240 and the second light detecting unit 270 so that the second light detecting unit 270 may detect the light of the second wavelength at higher resolution.

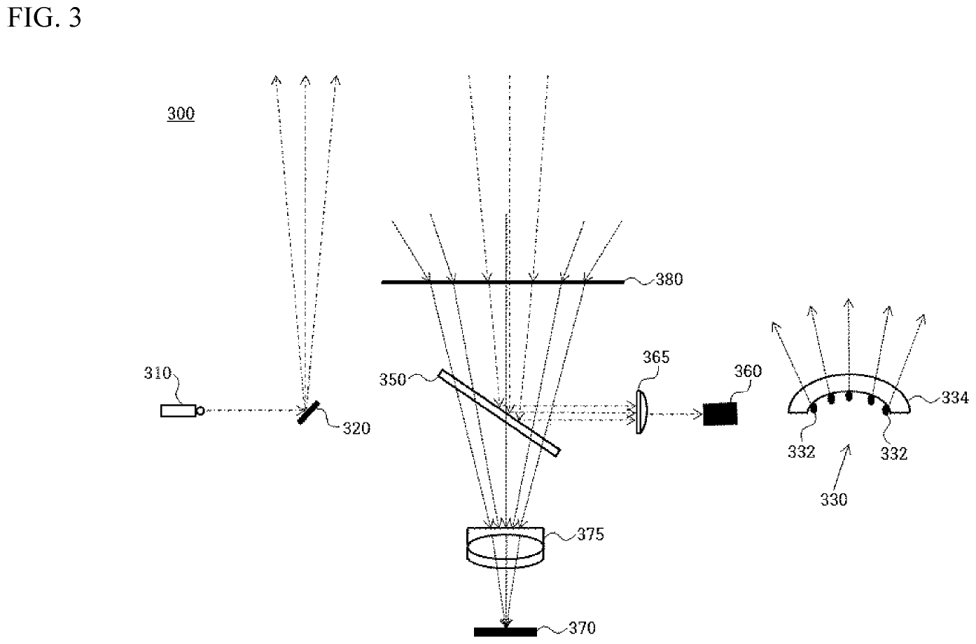

FIG. 3 is a view illustrating a LIDAR apparatus using dual wavelengths according to a third exemplary embodiment of the present invention.

Referring to FIG. 3, a LIDAR apparatus 300 using dual wavelengths according to a third exemplary embodiment of the present invention includes a first light source unit 310, a scan mirror 320, a second light source unit 330, a dichroic mirror 350, a first light detecting unit 360, and a second light detecting unit 370.

The LIDAR apparatus 100 using dual wavelengths according to the first exemplary embodiment of the present invention is configured so that the light of the first wavelength emitted by the first light source unit 110 is incident on the first dichroic mirror 140 through the scan mirror 120 and the light of the second wavelength emitted by the second light source unit 130 is also incident on the first dichroic mirror 140, but the LIDAR apparatus 300 using dual wavelengths according to the third exemplary embodiment of the present invention is configured so that light of a first wavelength emitted by the first light source unit 310 is directly sent to the outside of the LIDAR apparatus 300 through the scan mirror 320 and light of a second wavelength emitted by the second light source unit 330 is also directly sent to the outside of the LIDAR apparatus 300.

The first light source unit 310 emits the light of the first wavelength. In this case, the light of the first wavelength is to detect an object positioned outside the LIDAR apparatus 300 and positioned at a relatively long distance (for example, 200 m or more). It is sufficient that the LIDAR apparatus 300 may detect whether or not the object is positioned at the long distance, and the LIDAR apparatus 300 does not need to detect the object at high resolution. Therefore, it is preferable that the first light source unit 310 is a PLD emitting the light of the first wavelength in a pulse form. In a case where the first light source unit 310 is the PLD, the first light source unit 310 may emit the light of the first wavelength with relatively small power. In this case, since the light of the first wavelength has the pulse form, the light of the first wavelength may arrive at a relatively long distance from the LIDAR apparatus 300.

The light of the first wavelength emitted from the first light source unit 310 is incident to the scan mirror 320. Here, the scan mirror 320 may be a MEMS mirror in which a mirror is disposed on a MEMS semiconductor.

The scan mirror 320 is installed on a path of the light emitted from the first light source unit 310 so that a direction of a reflection surface thereof is varied over time, and serves to scan the light of the first wavelength emitted from the first light source unit 310 and send the scanned light to the outside of the LIDAR apparatus 300. For example, the scan mirror 320 is disposed on the path of the light of the first wavelength so as to be rotatable in a biaxial direction, such that the direction of the reflection surface of the scan mirror 320 may be varied over time. Here, the biaxial direction may refer to a horizontal direction and a vertical direction on the basis of a front surface of the scan mirror 320 in FIG. 3. In this case, the scan mirror 320 may rotate multiple times during a period in which it rotates once from the top to the bottom.

The second light source unit 330 emits the light of the second wavelength. In this case, the second wavelength is a wavelength different from the first wavelength. For example, in the present invention, the first wavelength may be 905 nm, and the second wavelength may be 800 nm.

The light of the second wavelength is to detect an object positioned outside the LIDAR apparatus 300 and positioned at a relatively short distance (for example, 20 m or less). The LIDAR apparatus 300 needs to detect the object positioned at the relatively short distance at high resolution. The reason is that when the LIDAR apparatus 300 is mounted in, for example, a vehicle or the like and such a vehicle is parked or travels at a low speed, an object in the vicinity of the vehicle needs to be detected at high resolution in order to ensure safety of the vehicle and a driver of the vehicle.

Therefore, the second light source unit 330 may be configured to one or more light emitting diodes (LEDs) 332 emitting the light of the second wavelength. One or more LEDs 332 may be disposed beneath a lens 334 in order to be stably disposed and diffuse the light of the second wavelength emitted from the LEDs 332. That is, the second light source 330 includes one or more LEDs 332 and the lens 334 beneath which the LEDs 332 are disposed.

A cross section of the lens 334 may have a semi-elliptical shape, and one or more LEDs 334 may be disposed beneath the lens 334 and emit the light of the second wavelength toward an upper portion of the lens 334. In addition, one of the LEDs 332 may be disposed at the center of the lens 334 beneath the lens 334, and the others of the LEDs 332 may be disposed at equal intervals at both sides of the LED disposed at the center of the lens 334. Light emission intensity and the number of the LEDs 332 may be appropriately selected depending on a distance at which the light of the second wavelength arrives at the outside of the LIDAR apparatus 300.

In a case where the second light source unit 330 is configured to include one or more LEDs 332, power consumed by the second light source unit 330 to emit the light of the second wavelength may be higher than power consumed by the first light source unit 310 to emit the light of the first wavelength. In this regard, the flash-type LIDAR apparatus according to the related art requires a light source consuming a very high power in order to simultaneously detect an object positioned at a short distance and an object positioned at a long distance. However, in the third exemplary embodiment of the present invention, the LIDAR apparatus 300 is configured to detect the object positioned at the long distance through the light of the first wavelength having the pulse form and detect the object positioned at the short distance through the light of the second wavelength emitted from one or more LEDs 332 and consumed power is thus reduced as compared with the flash-type LIDAR apparatus according to the related art, such that a cost of the LIDAR apparatus may be reduced and a size of the LIDAR apparatus may also be reduced.

The scan mirror 320 may scan the light of the first wavelength in a first angle range and send the scanned light to the outside of the LIDAR apparatus 300. In addition, the second light source unit 330 may emit the light of the second wavelength in a second angle range, which is an angle range wider than the first angle range, and send the emitted light to the outside of the LIDAR apparatus 300.

The light of the first wavelength scanned by the scan mirror 320 is to detect the object positioned at the relatively long distance, and an angle range of the LIDAR apparatus 300 does not need to be large when the LIDAR apparatus 300 detects the object positioned at the long distance. That is, since it is sufficient that the LIDAR apparatus 300 detects only whether or not the object is positioned at a long distance of a front surface, unnecessary power consumption caused by increasing the first angle range needs to be prevented. Therefore, it is preferable that the scan mirror 320 scans the light of the first wavelength in a relatively narrow angle range (for example, about 10°) and send the scanned light to the outside of the LIDAR apparatus 300.

The light of the second wavelength emitted from the second light source unit 330 is to detect the object positioned at the relative short distance, and it is preferable to make an angle range of the LIDAR apparatus 300 large when the LIDAR apparatus 300 detects the object positioned at the short distance. That is, the LIDAR apparatus 300 needs to detect not only the object positioned at the short distance in front of the LIDAR apparatus 300, but also the object positioned at the short distance at the high resolution so that the vehicle may be stably parked or stably travel at the low speed. Therefore, it is preferable that the second light source unit 330 emits the light of the second wavelength in a relatively wide angle range (for example, about 60°) and sends the emitted light to the outside of the LIDAR apparatus 300.

In a case where the object is positioned outside the LIDAR apparatus 300, the light of the first wavelength sent from the scan mirror 320 to the outside of the LIDAR apparatus 300 or the light of the second wavelength sent from the second light source unit 330 to the outside of the LIDAR apparatus 300 is reflected and returned by the object. In a case where the light of the first wavelength or the light of the second wavelength is incident on the object, scattered reflection is generated on the object. Therefore, the light of the first wavelength or the light of the second wavelength reflected and returned by the object may be incident to the first light detecting unit 360 or the second light detecting unit 370 through the dichroic mirror 350.

The dichroic mirror 350 reflects the light of the first wavelength reflected and returned by the object to allow the light of the first wavelength to be incident on a first light detecting unit 360 described below. In addition, the dichroic mirror 350 transmits the light of the second wavelength reflected and returned by the object to allow the light of the second wavelength to be incident on a second light detecting unit 370 described below. That is, the dichroic mirror 350 selectively reflects or transmits the light incident thereon according to a wavelength of the light.

Meanwhile, in order for the first light detecting unit 360 or the second light detecting unit 370 to detect the light at high resolution, each of the angle ranges of the light of the first wavelength and the light of the second wavelength that are reflected and returned by the object needs to be narrowed. Therefore, in the LIDAR apparatus 300 according to the third exemplary embodiment of the present invention, it is preferable that a wide angle lens 380 narrowing each of the angle ranges of the light of the first wavelength and the light of the second wavelength that are reflected and returned by the object is disposed in front of the dichroic mirror 350.

The first light detecting unit 360 detects the light of the first wavelength reflected by the dichroic mirror 350. Since the light of the first wavelength is light having the pulse form, it is preferable that the first light detecting unit 360 is an APD capable of detecting the light having the pulse form. In addition, a condensing lens 365 may be provided between the dichroic mirror 350 and the first light detecting unit 360 so that the first light detecting unit 360 may detect the light of the first wavelength at higher resolution.

The second light detecting unit 370 detects the light of the second wavelength transmitted through the dichroic mirror 350. Since the light of the second wavelength is light having the continuous wave form, it is preferable that the second light detecting unit 370 is a TOF sensor capable of detecting the light having the continuous wave form through a phase difference. In addition, an image optical system 375 may be provided between the dichroic mirror 350 and the second light detecting unit 370 so that the second light detecting unit 370 may detect the light of the second wavelength at higher resolution.

Although the present invention has been described with reference to the exemplary embodiments and the accompanying drawings, the present invention is not limited to the exemplary embodiments described above, and may be variously modified and changed from the above description by those skilled in the art to which the present invention pertains. Therefore, the scope and spirit of the present invention should be understood only by the claims, and all of the equivalences and equivalent modifications to the claims are intended to fall within the scope and spirit of the present invention.

### DETAILED DESCRIPTION OF MAIN ELEMENTS

100, 200, 300: LIDAR apparatus
110, 210, 310: first light source unit
120, 220, 320: scan mirror
130, 230, 330: second light source unit
140, 240: first dichroic mirror
150, 250: second dichroic mirror
160, 260, 360: first light detecting unit
170, 270, 370: second light detecting unit
180, 280: first wide angle lens
190, 290: second wide angle lens
332: LED
334: lens
350: dichroic mirror
380: wide angle lens

1. A light detection and ranging (LIDAR) apparatus using dual wavelengths, comprising:
a first light source unit emitting light of a first wavelength;
a scan mirror installed on a path of the light emitted from the first light source unit so that a direction of a reflection surface thereof is varied over time and scanning the light of the first wavelength emitted from the first light source unit;
a second light source unit emitting light of a second wavelength which is a wavelength different from the first wavelength;
a first dichroic mirror reflecting the light of the first wavelength scanned by the scan mirror, transmitting the light of the second wavelength emitted from the second light source unit, and sending the light of the first wavelength and the light of the second wavelength to the outside of the LIDAR apparatus;
a second dichroic mirror reflecting the light of the first wavelength reflected and returned by an object positioned outside the LIDAR apparatus and transmitting the light of the second wavelength reflected and returned by an object positioned outside the LIDAR apparatus;
a first light detecting unit detecting the light of the first wavelength reflected by the second dichroic mirror; and
a second light detecting unit detecting the light of the second wavelength transmitted through the second dichroic mirror.

2. The LIDAR apparatus using dual wavelengths of claim 1, wherein the first light source unit is a pulsed laser diode (PLD) emitting the light of the first wavelength in a pulse form.

3. The LIDAR apparatus using dual wavelengths of claim 2, wherein the first light detecting unit is an avalanche photo diode (APD).

4. The LIDAR apparatus using dual wavelengths of claim 1, wherein the second light source unit is a continuous wave laser diode (CWLD) emitting the light of the second wavelength in a continuous wave form.
The LIDAR apparatus using dual wavelengths of claim 4, wherein the second light detecting unit is a time-of-flight (TOF) sensor.

5. The LIDAR apparatus using dual wavelengths of claim 1, wherein the scan mirror scans the light of the first wavelength in a first angle range, and
the second light source unit emits the light of the second wavelength in a second angle range which is an angle range wider than the first angle range.

7. The LIDAR apparatus using dual wavelengths of claim 6, further comprising a first wide angle lens extending each of the angle ranges of the light of the first wavelength reflected by the first dichroic mirror and the light of the second wavelength transmitted through the first dichroic mirror.

8. The LIDAR apparatus using dual wavelengths of claim 7, further comprising a second wide angle lens narrowing each of the angle ranges of the light of the first wavelength reflected and returned by the object and the light of the second wavelength reflected and returned by the object.

9. A LIDAR apparatus using dual wavelengths, comprising:
a first light source unit emitting light of a first wavelength;
a scan mirror installed on a path of the light emitted from the first light source unit so that a direction of a reflection surface thereof is varied over time and scanning the light of the first wavelength emitted from the first light source unit;
a first dichroic mirror reflecting the light of the first wavelength scanned by the scan mirror and sending the light of the first wavelength to the outside of the LIDAR apparatus;
a second light source unit emitting light of a second wavelength which is a wavelength different from the first wavelength;
a second dichroic mirror reflecting the light of the second wavelength emitted from the second light source unit and sending the light of the second wavelength to the outside of the LIDAR apparatus;
a first light detecting unit detecting the light of the first wavelength reflected and returned by an object positioned outside the LIDAR apparatus and transmitted through the second dichroic mirror; and
a second light detecting unit detecting the light of the second wavelength reflected and returned by an object positioned outside the LIDAR and transmitted through the first dichroic mirror.

10. The LIDAR apparatus using dual wavelengths of claim 9, wherein the first light source unit is a PLD emitting the light of the first wavelength in a pulse form.

11. The LIDAR apparatus using dual wavelengths of claim 10, wherein the first light detecting unit is an APD.

12. The LIDAR apparatus using dual wavelengths of claim 9, wherein the second light source unit is a CWLD emitting the light of the second wavelength in a continuous wave form.

13. The LIDAR apparatus using dual wavelengths of claim 12, wherein the second light detecting unit is a TOF sensor.

14. The LIDAR apparatus using dual wavelengths of claim 9, wherein the scan mirror scans the light of the first wavelength in a first angle range, and
the second light source unit emits the light of the second wavelength in a second angle range which is an angle range wider than the first angle range.

15. The LIDAR apparatus using dual wavelengths of claim 14, further comprising:
a first wide angle lens extending the angle range of the light of the first wavelength reflected by the first dichroic mirror; and
a second wide angle lens extending the angle range of the light of the second wavelength reflected by the second dichroic mirror.

16. A LIDAR apparatus using dual wavelengths, comprising:
a first light source unit emitting light of a first wavelength;
a scan mirror installed on a path of the light emitted from the first light source unit so that a direction of a reflection surface thereof is varied over time, scanning the light of the first wavelength emitted from the first light source unit, and sending the scanned light to the outside of the LIDAR apparatus;
a second light source unit emitting light of a second wavelength which is a wavelength different from the first wavelength and sending the light of the second wavelength to the outside of the LIDAR apparatus;
a dichroic mirror reflecting the light of the first wavelength reflected and returned by an object positioned outside the LIDAR apparatus and transmitting the light of the second wavelength reflected and returned by an object positioned outside the LIDAR apparatus;
a first light detecting unit detecting the light of the first wavelength reflected by the dichroic mirror; and
a second light detecting unit detecting the light of the second wavelength transmitted through the dichroic mirror.

17. The LIDAR apparatus using dual wavelengths of claim 16, wherein the first light source unit is a PLD emitting the light of the first wavelength in a pulse form.

18. The LIDAR apparatus using dual wavelengths of claim 17, wherein the first light detecting unit is an APD.

19. The LIDAR apparatus using dual wavelengths of claim 16, wherein the second light source unit includes one or more light emitting diodes (LEDs) emitting the light of the second wavelength in a continuous wave form.

20. The LIDAR apparatus using dual wavelengths of claim 19, further comprising a lens beneath which the one or more LEDs are disposed,
wherein the one or more LEDs are disposed beneath the lens and emit the light of the second wavelength toward an upper portion of the lens.

21. The LIDAR apparatus using dual wavelengths of claim 19, wherein the second light detecting unit is a TOF sensor.

22. The LIDAR apparatus using dual wavelengths of claim 16, wherein the scan mirror scans the light of the first wavelength in a first angle range, and
the second light source unit emits the light of the second wavelength in a second angle range which is an angle range wider than the first angle range.

23. The LIDAR apparatus using dual wavelengths of claim 22, further comprising a wide angle lens narrowing each of the angle ranges of the light of the first wavelength reflected and returned by the object and the light of the second wavelength reflected and returned by the object.
